(19) United States
(12) Patent Application Publication
(10) Pub. No.: US 2014/0057190 A1
(43) Pub. Date: Feb. 27, 2014

(54) DIRECT OXIDATION TYPE FUEL CELL SYSTEM

(71) Applicants: Masaki Mitsui, Kyoto (JP); Takashi Akiyama, Osaka (JP); Junya Kusumoto, Nara (JP)

(72) Inventors: Masaki Mitsui, Kyoto (JP); Takashi Akiyama, Osaka (JP); Junya Kusumoto, Nara (JP)

(73) Assignee: PANASONIC CORPORATION, Osaka (JP)

(21) Appl. No.: 14/007,297

(22) PCT Filed: Nov. 19, 2012
(86) PCT No.: PCT/JP2012/007421

§ 371 Date: Sep. 24, 2013

(30) Foreign Application Priority Data
Dec. 28, 2011 (JP) 2011-288446

(51) Int. Cl. H01M 8/04

(52) U.S. Cl. CPC H01M 8/04253
USPC 429/429

(57) ABSTRACT

Disclosed is a fuel cell system comprising: a fuel cell including an anode and a cathode to which a water-soluble fuel and an oxidant are supplied, respectively, and a water-permeable electrolyte membrane interposed therebetween; a fuel tank; a first fuel supply unit which supplies an aqueous fuel solution to the anode; a second fuel supply unit which supplies the fuel to the first fuel supply unit; an oxidant supply unit which supplies an oxidant to the cathode; a temperature sensor which detects a temperature FT of the fuel cell; and a control unit which controls the first, second, and oxidant supply units, and the fuel cell whether to start or stop power generation. The control unit allows at least the first fuel supply unit to operate while the fuel cell is stopped from generating power, provided that the temperature FT of the fuel cell as such meets specific requirements.

### TECHNICAL FIELD

The present invention relates to a direct oxidation fuel cell system, and specifically, to a freeze proofing of a fuel cell in a low-temperature environment.

### BACKGROUND ART

Fuel cells are becoming commercially available as the power source for automobiles, home cogeneration systems, etc. Recently, studies are also being conducted on use of fuel cells as the power source for small mobile electronic devices such as laptop computers, cellular phones, and personal digital assistants (PDAs);outdoor recreation; and emergency backup power. Since fuel cells can generate power continuously by being refueled, they are expected to further improve the convenience of small mobile electronic devices and portable power supplies.

Among fuel cells, direct oxidation fuel cells (DOFCs) generate electrical energy by directly oxidizing fuel that is liquid at room temperature. Therefore, DOFCs can easily be reduced in size. Direct methanol fuel cells (DMFCs), which use methanol as fuel, are better in energy efficiency and output power when compared to other direct oxidation fuel cells, and are seen as most promising among DOFCs.

A fuel cell includes a stack in which two or more cells are connected in series. Each of the cells includes: a membrane electrode assembly including an electrolyte membrane, and an anode and a cathode disposed on one side and the other side of the electrolyte membrane; an anode-side separator in contact with the anode; and a cathode-side separator in contact with the cathode. The anode-side separator has a fuel flow channel which supplies a liquid fuel (aqueous fuel solution), to the anode; and the cathode-side separator has an oxidant flow channel which supplies an oxidant, to the cathode. The liquid fuel and the oxidant are supplied to the fuel cell, by a supply unit such as a pump.

Reactions at the anode and the cathode in a DMFC are expressed by the following formulae (11) and (12). Oxygen introduced into the cathode is typically taken from the air.

Anode: CH₃OH+H₂O→CO₂+6H⁺+6e⁻ (11)

Cathode: (3/2)O₂+6H⁺+6e⁻→3H₂O (12)

At the anode, methanol reacts with water, thereby producing carbon dioxide. A fuel discharge liquid including the carbon dioxide and unreacted fuel, together with newly-supplied fuel, is sent from the anode to a tank (hereafter, circulation tank) which enables circulation of fuel and water in the system. On the other hand, at the cathode, water is produced in an amount more than the amount consumed at the anode. A part of a fluid including product water and unreacted oxygen, is also sent to the circulation tank.

For the fuel cell to start generating power, water stored in the circulation tank is mixed with a high concentration methanol in a fuel tank, and the resultant is supplied to the fuel cell; and air, i.e., the oxidant, is supplied to the cathode.

In the foregoing system, a water-soluble fuel and water (i.e, aqueous fuel solution) are present inside the following: the fuel cell, a pipe connecting the anode and the circulation tank, a pipe connecting the cathode and the circulation tank, a pump (hereafter, circulating pump) for fuel and water circulations, etc. The aqueous fuel solution may freeze in a low temperature environment; and pressure due to volume expansion at the time of freezing may presumably damage the components which compose the circulation system.

In connection with the foregoing, Patent Literature 1 proposes a method in which a fuel cell is prevented from freezing due to heat generated during power generation by the fuel cell, the power generation being made to stop when the fuel cell temperature increases and reaches a predetermined temperature. Moreover, Patent Literature 2 proposes discharging product water from a fuel cell when at a low temperature, to the outside, so that components are prevented from being damaged due to freezing.

### CITATION LIST

### Patent Literature

[Patent Literature 1] Japanese Laid-Open Patent Publication No. 2003-151601

[Patent Literature 2] Japanese Laid-Open Patent Publication No. 2010-108757

### SUMMARY OF INVENTION

### Technical Problem

As with the method disclosed in Patent Literature 1, to prevent a fuel cell from freezing by heat generated during power generation by the fuel cell, it would become necessary for the fuel cell to repeat the process of generating power and stopping generating power; and with each repetition, more time would be required to start and warm up the fuel cell, and larger amount of fuel would be consumed to prevent the fuel cell from freezing.

Moreover, Patent Literature 2 proposes releasing an aqueous fuel solution from inside a circulation system, to the outside. However, in a DMFC, since methanol is used as fuel, it would not be preferable to release an aqueous solution thereof to the outside.

### Solution to Problem

One aspect of the present invention is directed to a fuel cell system comprising:
a fuel cell including: an anode to which a water-soluble fuel is supplied; a cathode to which an oxidant is supplied; and a water-permeable electrolyte membrane interposed between the anode and the cathode;
a fuel tank which stores the fuel;
a first fuel supply unit which supplies an aqueous fuel solution including the fuel and water, to the anode;
a second fuel supply unit which supplies the fuel stored in the fuel tank, to the first fuel supply unit;
an oxidant supply unit which supplies the oxidant to the cathode;
a temperature sensor which detects a temperature FT of the fuel cell; and
a control unit which controls the first, second, and oxidant supply units; and which controls the fuel cell whether to start or stop power generation,
the control unit allowing at least the first fuel supply unit to operate while the fuel cell is stopped from generating power, provided that the temperature FT of the fuel cell while being stopped from generating power, is equal to or lower than a first reference temperature relating to freezing of water and is also equal to or higher than a second reference temperature.

The present invention can comprise, for example:
a fuel cell stack comprising:
   at least one membrane-electrode assembly;
   a fuel inlet which introduces a fuel;
   a fuel outlet which releases a fuel discharge liquid;
   an oxidant inlet which introduces an oxidant; and
   an oxidant outlet which releases a fluid including unconsumed oxidant and product water;
a first fuel supply unit which supplies the fuel to the fuel inlet;

an oxidant supply unit which supplies the oxidant to the oxidant inlet;
a circulation tank which stores the fuel discharge liquid and a part of the product water;
a fuel discharge channel which leads the fuel discharge liquid to the circulation tank;
a product water discharge channel which leads at least a part of the product water to the circulation tank; and
a second fuel supply unit which injects a high concentration fuel stored in a fuel tank, to a channel between the circulation tank and the first fuel supply unit,
wherein a temperature inside the system is increased by utilizing heat generated due to fuel crossover.

Alternatively, the present invention can comprise, for example:
a fuel cell stack comprising:
   at least one membrane-electrode assembly;
   a fuel inlet which introduces a fuel;
   a fuel outlet which releases a fuel discharge liquid;
   an oxidant inlet which introduces an oxidant; and
   an oxidant outlet which releases a fluid including unconsumed oxidant and product water;
a first fuel supply unit which supplies the fuel to the fuel inlet;
an oxidant supply unit which supplies the oxidant to the oxidant inlet;
a circulation tank which stores the fuel discharge liquid and a part of the product water;
a fuel discharge channel which leads the fuel discharge liquid to the circulation tank;
a product water discharge channel which leads at least
a part of the product water to the circulation tank; and
a second fuel supply unit which injects a high concentration fuel stored in a fuel tank, to a channel between the circulation tank and the first fuel supply unit;
a temperature sensor which detects a temperature of at least one of the fuel cell, the first fuel supply unit, the second fuel supply unit, the circulation tank, the fuel discharge channel, and an outside atmospheric temperature (ambient temperature);
a control unit which controls power generation by the fuel cell;
a determining unit which determines possibility of freezing occurring, based on a result obtained by the temperature sensor; and
a memory which pre-stores a table of temperature vs. required amount of heat,
wherein a temperature inside the system is increased based on the table of temperature vs. required amount of heat that is pre-stored in the memory, with use of heat generated due to power generation by the fuel cell and due to fuel crossover.

### Advantageous Effects of Invention

According to the present invention, the amount of fuel consumption can be suppressed, while effectively preventing freezing of the fuel cell.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWINGS

FIG. 1 is a block diagram schematically showing the structure of a direct oxidation fuel cell system according to one embodiment of the present invention.

FIG. 2 is a vertical sectional view showing an example of a fuel cell used in the system of FIG. 1.

FIG. 3 is a flow chart showing steps in a process of freeze proofing in the system of FIG. 1.

FIG. 4 is a graph showing a relation between an ambient or cell temperature, and an amount of heat required for freeze proofing the fuel cell.

FIG. 5 is a graph showing a characteristic curve of voltage generated vs. current generated, of the fuel cell.

FIG. 6 is a graph showing an example of a relation between the following: an amount of heat to be generated by power generation, the amount required for preventing freezing of the fuel cell; and the ambient or fuel cell temperature.

### DESCRIPTION OF EMBODIMENTS

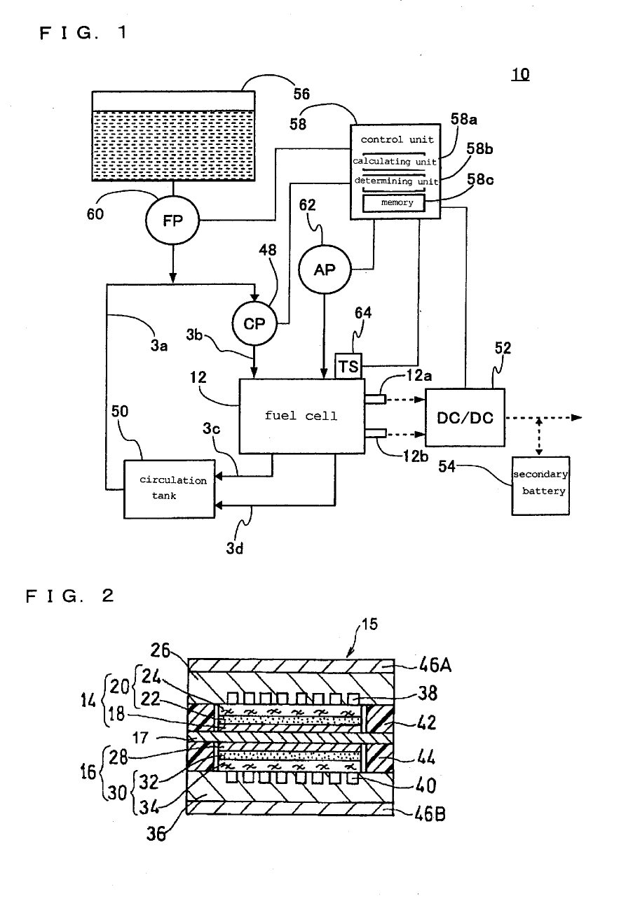

In the following, a direct oxidation fuel cell system of the present invention will be described with reference to drawings. In FIG. 1, the structure of a direct oxidation fuel cell system according to one embodiment of the present invention, is shown by a block diagram. In FIG. 2, an example of a fuel cell used in the system, is shown by a vertical sectional view thereof.

A direct oxidation fuel cell system 10 (hereafter, simply referred to as system 10) shown in FIG. 1 comprises:
a fuel cell 12, i.e., a DFMC;
a circulating pump 48, i.e., a first fuel supply unit which supplies an aqueous fuel solution including a water-soluble fuel and water, to a fuel inlet of the fuel cell 12;
a fuel pump 60, i.e., a second fuel supply unit which supplies a high concentration fuel from a fuel tank 56, to a suction side of the circulating pump 48; and
an air pump 62, i.e., an oxidant supply unit which supplies an oxidant, to an oxidant inlet of the fuel cell 12.

A fuel outlet (discharge outlet for unused fuel, etc.) of the fuel cell 12 is connected to a circulation tank 50; and an oxidant outlet (discharge outlet for unused oxidant, etc.) of the fuel cell 12 is also connected to the circulation tank 50. The circulation tank 50 is connected to the suction side of the circulating pump 48.

Respective outputs (flow rate) of the circulating pump 48, the fuel pump 60, and the air pump 62 are controlled by a control unit 58. The control unit 58 uses a microcomputer comprising a calculating unit 58a, a determining unit 58b, and a memory 58c. The memory 58c stores various pre-set data such as a first temperature T1, a second temperature T2, a third temperature T3, and a table of cell temperature vs. required amount of heat. Output power of the fuel cell 12 is output to the outside via, e.g., a DC/DC converter 52. The DC/DC converter 52 can be controlled by the control unit 58. A storage cell 54, which stores power generated by the fuel cell 12, may be connected to an output side of the DC/DC converter 52.

Furthermore, the system 10 includes a temperature sensor 64 which detects a temperature FT of the fuel cell 12 (hereafter, cell temperature FT), or an internal temperature of a circulation system that will be described later. The cell temperature FT detected by the temperature sensor 64 is entered into the control unit 58. The cell temperature FT may be indirectly detected, through detection of a temperature of any part of the circulation system. Conversely, a temperature of each part of the circulation system may be indirectly detected, through detection of the cell temperature FT. Alternatively, the cell temperature FT may be indirectly detected, through detection of an ambient temperature. Conversely, the ambient temperature may be indirectly detected, through detection of the cell temperature FT. Therefore, the ambient temperature or the temperature of any part of the circulation system may be detected, to be used in place of the cell temperature FT or to detect the cell temperature FT.

The fuel cell 12 has the fuel inlet (not shown) which introduces the water-soluble fuel, the fuel outlet which releases a fuel discharge liquid, the oxidant inlet which introduces the oxidant, and the oxidant outlet which releases a fluid (discharge fluid) containing the unconsumed oxidant and product water. The main body of the fuel cell typically includes a stack in which two or more cells are electrically connected in series.

FIG. 2 schematically shows a vertical sectional view of the structure of the cell. The cell 15 is a direct methanol fuel cell, and includes a polymer electrolyte membrane 17, and an anode 14 and a cathode 16 disposed such that they hold the polymer electrolyte membrane 17 in between. The polymer electrolyte membrane 17 is conductive to hydrogen ions. Methanol, i.e., the fuel, is supplied to the anode 14. Air, i.e., the oxidant, is supplied to the cathode 16.

In a direction in which the anode 14, the polymer electrolyte membrane 17, and the cathode 16 are laminated, an anode-side separator 26 is laminated on the anode 14; and further disposed on the anode-side separator 26, is an end plate 46A. Moreover, a cathode-side separator 36 is laminated on the cathode 16 (laminated in a downward direction in FIG. 2); and further disposed on the cathode-side separator 36, is an end plate 46B. In the case where two or more of the cell 15 are stacked, the end plates 46A and 46B are not disposed for each of the cell, and instead, are disposed on one end and the other end of the cell stack in the stacked direction. Each of the end plates serve as a current collector plate which sends power to output terminals 12a and 12b. Power generated by the fuel cell is sent to an external load (not shown) or the storage cell 54, via the DC/DC converter 52.

A gasket 42 is disposed between the anode-side separator 26 and the polymer electrolyte membrane 17, such that the gasket 42 surrounds the anode 14; and a gasket 44 is disposed between the cathode-side separator 36 and the polymer electrolyte membrane 17, such that the gasket 44 surrounds the cathode 16. The gaskets 42 and 44 each prevent the fuel and the oxidant from leaking out of the anode 14 and the cathode 16, respectively.

The separators and the MEA (Membrane Electrode Assembly) are clamped together via the end plates 46A and 46B, through application of pressure with use of bolts, springs, etc. (not shown), thereby producing the cell 15.

The anode 14 includes an anode catalyst layer 18 and an anode diffusion layer 20. The anode catalyst layer 18 is in contact with the polymer electrolyte membrane 17. The anode diffusion layer 20 includes: an anode porous substrate 24 that is treated with a water repellent finish; and an anode water-repellent layer 22 made of a highly water-repellent material, formed on a surface of the anode porous substrate 24. The anode water-repellent layer 22 and the anode porous substrate 24 are laminated, in this order, on a surface of the anode catalyst layer 18 that is opposite of a surface thereof in contact with the polymer electrolyte membrane 17.

The cathode 16 includes a cathode catalyst layer 28 and a cathode diffusion layer 30. The cathode catalyst layer 28 is in contact with a surface of the polymer electrolyte membrane 17 that is opposite of a surface thereof in contact with the anode catalyst layer 18. The cathode diffusion layer 30 includes: a cathode porous substrate 34 that is treated with a water-repellent finish; and a cathode water-repellent layer 32 made of a highly water-repellent material, formed on a surface of the cathode porous substrate 34. The cathode water-repellent layer 32 and the porous cathode substrate 34 are laminated, in this order, on a surface of the cathode catalyst layer 28 that is opposite of a surface thereof in contact with the polymer electrolyte membrane 17.

A laminate comprising the polymer electrolyte membrane 17, the anode catalyst layer 18, and the cathode catalyst layer 28, serves to generate power in the fuel cell, and is called CCM (Catalyst Coated Membrane). Moreover, the MEA is a laminate comprising the CCM, the anode diffusion layer 20, and the cathode diffusion layer 30. The anode diffusion layer 20 and the cathode diffusion layer 30 serve to uniformly disperse the fuel supplied to the anode 14 and the oxidant supplied to the cathode 16, respectively; and also serve to smoothly discharge water and carbon dioxide that are produced.

The anode-side separator 26 has a fuel flow channel 38 which supplies the fuel to the anode 14, on a surface of the anode-side separator 26 in contact with the anode porous substrate 24. The fuel flow channel 38 is, e.g., formed on the contact surface as above, and takes the form of recess or groove which is open toward the anode porous substrate 24. The fuel flow channel extends from the fuel inlet to the fuel outlet of the fuel cell 12.

The cathode-side separator 36 has an oxidant flow channel 40 which supplies the oxidant (air) to the cathode 16, on a surface of the cathode-side separator 36 in contact with the cathode porous substrate 34. The oxidant flow channel 40 is, e.g., also formed on the contact surface as above, and takes the form of recess or groove which is open toward the cathode porous substrate 34. The oxidant flow channel extends from the oxidant inlet to the oxidant outlet of the fuel cell.

The circulating pump 48 is connected to the circulation tank 50 and the fuel pump 60. The fuel pump 60 is connected to the fuel tank 56 which stores the high concentration fuel. The high concentration fuel is injected into a pipe 3a which connects the suction portion of the circulating pump 48 and the circulation tank 50. As a result, an aqueous fuel solution, i.e., a mixture including water from the circulation tank 50 and the high concentration fuel, is introduced into the fuel cell 12, via a pipe 3b which connects the fuel inlet of the fuel cell and the circulating pump 48.

The aqueous fuel solution introduced into the fuel cell 12, is further introduced into the fuel flow channel that is inside, from the fuel inlet of the fuel cell 12. The fuel that flows through the fuel flow channel, passes through the flow channel while also being consumed to generate power. Eventually, the aqueous fuel solution is discharged from the fuel outlet of the fuel cell 12, as the fuel discharge liquid containing carbon dioxide. The fuel discharge liquid, although with reduced fuel concentration, contains unreacted fuel. Thus, the fuel discharge liquid is reused, after the carbon dioxide is separated therefrom. For this purpose, the fuel discharge liquid is collected into the circulation tank 50, via a pipe 3c which connects the fuel outlet of the fuel cell 12 and the circulation tank 50.

There is no particular limitation to a method of separating the carbon dioxide from the fuel discharge liquid. For example, the circulation tank 50 may be provided with a window, and the window may be covered with a gas-liquid separation film capable of passing carbon dioxide therethrough, thereby allowing the carbon dioxide to be discharged to the outside.

The air pump 62 serves to take in the air from the outside, and lead it, as the oxidant, to the oxidant inlet of the fuel cell 12. The oxidant supply unit includes at least the air pump 62. A part in the control unit 58 which controls the air pump 62, can be regarded as a part of the oxidant supply unit. Likewise, a part in the control unit 58 which controls the circulating pump 48, can be regarded as a part of the first fuel supply unit; and a part in the control unit 58 which controls the fuel pump 60, can be regarded as being a part of the second fuel supply unit.

The air is introduced into the oxidant flow channel, from the oxidant inlet of the fuel cell 12; and passes through the flow channel, while oxygen in the air is consumed. Eventually, the air is discharged from the oxidant outlet of the fuel cell 12, as a discharge fluid containing steam (product water). The discharge fluid is introduced into the circulation tank 50 by pressure of the air pump 62, via a pipe 3d which connects the oxidant outlet of the fuel cell 12 and the circulation tank 50.

In the circulation tank 50, the product water is partially separated from the discharge fluid, and then collected; and the remainder of the product water is released to the outside. In the case where methanol is used as the fuel, theoretically, every time one mole of water is consumed at the anode, three moles of water are produced at the cathode. Therefore, by having the product water in an amount worth one mole be collected into the circulation tank 50, water in an almost fixed amount can be theoretically maintained within the system. The remaining water in an amount worth two moles is released to the outside of the circulation tank 50. The product water that has been separated, is collected into the circulation tank 50.

As such, the fuel and the oxidant can be supplied to the fuel cell 12 for power generation. During power generation, the resultant heat generation causes the temperature of the fuel cell to rise, and the temperature thereof is maintained at an almost fixed temperature. However, if the fuel cell is left in a low temperature environment while it is stopped from generating power, water remaining in the fuel cell 12, the circulation tank 50, and the circulating pump 48, and in the pipes 3a to 3d which connect the foregoing (hereafter, these parts will be collectively referred to as circulation system) may freeze. If the water freezes, the resultant swelling pressure may cause damage to the parts of the circulation system. In the present embodiment, heat generated due to fuel crossover is utilized to prevent the water from freezing; and thus, the parts of the circulation system is prevented from being damaged.

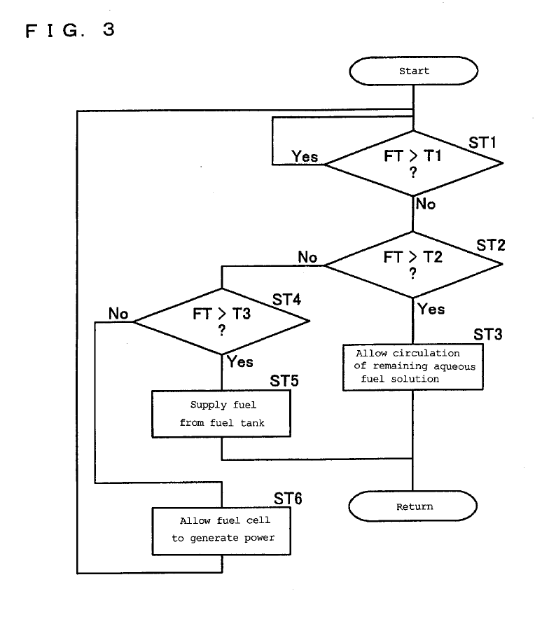

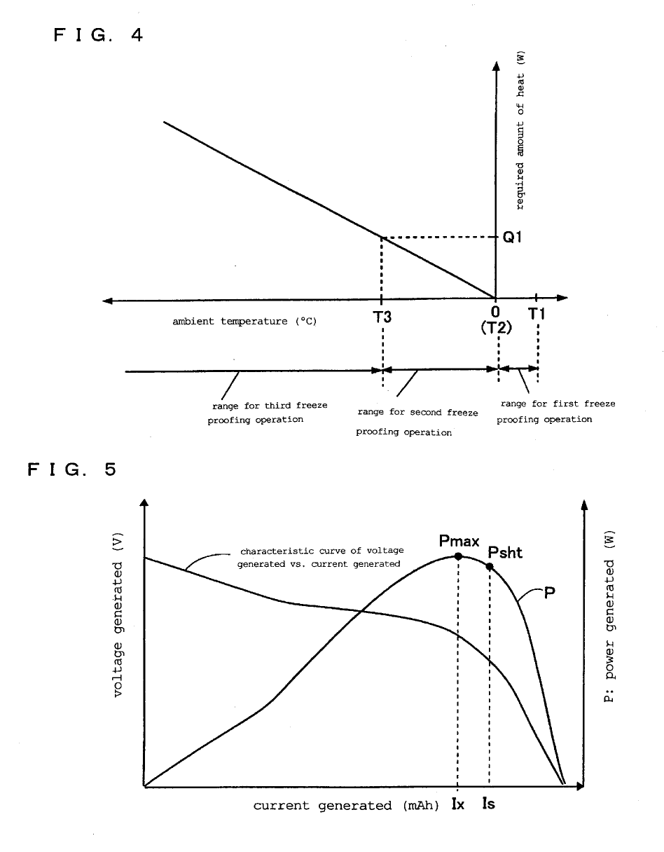

In the following, by referring to the drawings, a description will be given on a freeze proofing process that is carried out, so that the fuel cell, while stopped from generating power, is prevented from freezing in a low temperature environment. FIG. 3 is a flow chart showing the flow of the freeze proofing process. In the present freeze proofing process, three freeze proofing operations, i.e., first, second, and third freeze proofing operations, are carried out in accordance with the temperature of the fuel cell. FIG. 4 is a graph showing a relation between the ambient or fuel cell temperature, and the required amount of heat for freeze proofing.

First, the temperature FT of the fuel cell 12 (hereafter, cell temperature FT) is determined whether it is equal to or lower than the first temperature T1, i.e., a reference temperature used when carrying out the first freeze proofing operation (ST1). The determination is made by the determining unit 58b in the control unit 58. If the cell temperature FT is higher than the first temperature T1 (Yes at ST1), since there is no problem in particular, none of the freeze proofing operations are carried out, and the step ST1 for the determination is repeated after a predetermined time (e.g., 0.1 second) elapses. The step ST1 for the determination is repeated until the cell temperature FT becomes equal to or lower than the first temperature T1.

In the step ST1, if the cell temperature FT is equal to or lower than the first temperature T1 (No at ST1), the cell temperature FT is further determined whether it is equal to or lower than a second temperature T2 (T2<T1), i.e., a reference temperature used when carrying out the second freeze proofing operation (ST2). The determination is made by the determining unit 58b in the control unit 58. Here, if the cell temperature FT is higher than the second temperature T2 (Yes at ST2), then, T2<FT≦T1; and the control unit 58 makes the circulating pump 48 operate at a flow rate F1, so that the first freeze proofing operation gets started (ST3), for preventing the fuel cell 12 from freezing. Thus, the aqueous fuel solution (aqueous methanol solution) with a first concentration FC1 in the circulation tank 50 is supplied to the fuel cell 12, fuel crossover occurs, and heat is generated by the fuel cell 12. The following gives a detailed description on this point.

Freezing starts, when the respective temperatures of the parts of the circulation system, specifically, the respective temperatures of the residual water inside the following, becomes equal to or lower than 0° C.: the fuel cell 12; the circulating pump 48; the circulation tank 50; the pipe 3a which connects the circulating pump 48 and the circulation tank 50; the pipe 3b which connects the circulating pump 48 and the fuel cell 12; the pipe 3c which sends the aqueous solution of the unconsumed fuel at the anode, from the fuel cell 12 to the circulation tank 50; and the pipe 3d which sends the product water produced by a reaction at the cathode, from the fuel cell 12 to the circulation tank 50. Therefore, freezing can be prevented if the respective temperatures of the parts of the circulation system are all adjusted to a target temperature that is higher than 0° C.

From the foregoing, the first temperature T1 is preferably set to a temperature within a range of 0 to 5° C. By setting as above, the first freeze proofing operation can be started while the respective temperatures of the parts of the circulation system are all higher than 0° C. In the first freeze proofing operation, the circulating pump 48 is operated, so that the aqueous fuel solution having the first concentration FC1 and remaining in the parts (primarily in the circulation tank 50) of the circulation system, is supplied to the anode in the fuel cell 12. The fuel concentration (methanol concentration, i.e., FC1) of the aqueous fuel solution remaining in the parts of the circulation system is usually very low, being about 0.2 to 0.5 mol/L.

At least a part of the fuel supplied to the anode permeates the polymer electrolyte membrane and reaches the cathode, and is oxidized by oxygen remaining at the cathode. This phenomenon is called fuel crossover. As mentioned above, the fuel concentration in the aqueous fuel solution remaining in the circulation tank 50 is very low; and therefore, very little heat is generated by an oxidation reaction caused by the above-mentioned fuel crossover. Thus, rather than being an operation for preventing the fuel cell system 10 from freezing, the first freeze proofing operation is more of a preparatory operation for the second freeze proofing operation which starts when the temperature of the fuel cell system 10 becomes further lower. That is, the purpose of the first freeze proofing operation is to preheat the water remaining in the circulation system, before the respective temperatures of the parts of the circulation system become 0° C. or lower. This prevents the water in the circulation system from freezing, even when the parts of the circulation system become 0° C. or lower.

In the step ST3, the circulating pump 48 starts operating, and after a predetermined time (e.g., 0.1 second) elapses, the process reverts back to the step ST1. As long as T2<FT T1, the steps of ST1, ST2, and ST3 are carried out repeatedly. That is, as long as these steps are repeated, the first freeze proofing operation is carried out continuously. On the other hand, in the step ST2, if the cell temperature FT is determined as being equal to or lower than the second temperature T2 (No at ST2), the cell temperature FT is further determined whether it is equal to or lower than the third temperature T3 which is a reference temperature used when carrying out the third freeze proofing operation (ST4). This determination is carried out by the determining unit 58b in the control unit 58.

Here, if the cell temperature FT is higher than the third temperature T3 (Yes at ST4), then, T3<FT≦T2, and the control unit 58 makes the fuel pump 60 operate at a flow rate F2, so that the second freeze proofing operation is carried out (ST5). At that time, the operation of the circulating pump 48 is also continued. This enables the aqueous fuel (methanol) solution with a high concentration (e.g., 50 mass% or higher) to be supplied to the circulation system, from the fuel tank 56; and enables the aqueous fuel solution with a second concentration FC2, which is higher than the first concentration FC1, to be supplied to the fuel cell 12. As a result, the amount of fuel crossover increases, and the amount of heat generated by the fuel cell 12 becomes larger than that during the first freeze proofing operation.

Here, the second concentration FC2 is preferably 0.5 to 4 mol/L. Although the following would depend on fuel diffusability and proton conductivity of the MEA, if the second concentration FC2 becomes lower than 0.5 mol/L, fuel crossover would be small and sufficient heat generation would thus become unlikely. Alternatively, since power generated by the fuel cell 12 after transition to the third freeze proofing operation (to be described later) would decrease significantly, sufficient heat generation would thus become unlikely. Moreover, it can be presumed that, if the second concentration FC2 exceeds 4 mol/L, the amount of fuel crossover would increase, and such increase would cause the MEA to degrade and the power generated by the fuel cell 12 to become reduced. Here, the second freeze proofing operation is carried out when the respective temperatures of the parts of the circulation system are 0° C. or lower, and furthermore, when heat generated due to fuel crossover is more than the amount of heat required to raise the temperature of the circulation system (hereafter, simply referred to as required amount of heat). This will be described in detail, in the following.

FIG. 4 shows a relation between the required amount of heat and the ambient or cell temperature, by a graph. As shown in the graph, the required amount of heat becomes larger as the ambient temperature becomes lower. Therefore, if the ambient temperature becomes lower, the heat generated due to fuel crossover alone would not suffice to prevent the fuel cell from freezing. Therefore, the third temperature T3 is set to a temperature that is slightly higher than the minimum temperature capable of preventing the fuel cell from freezing by heat generated due to fuel crossover. Thus, as long as the fuel cell can be prevented from freezing by only heat generated due to fuel crossover, the fuel cell is prevented from freezing by the first or second freeze proofing operation. Thus, the fuel cell can be prevented from freezing with minimum fuel consumption, and the amount of the fuel to be consumed can be conserved.

In the step ST5, the fuel pump 60 starts operating, and after a predetermined time (e.g., 0.1 second) elapses, the process reverts back to the step ST1. As long as T3<FT≦T2, the steps of ST1, ST2, ST4, and ST5 are carried out repeatedly. That is, as long as these steps are repeated, the second freeze proofing operation is carried out continuously. On the other hand, in the step ST4, if the cell temperature FT is determined as being equal to or lower than the third temperature T3 (No at ST4), the control unit 58 makes the air pump 62 start and makes the fuel cell 12 start generating power, so that the third freeze proofing operation would be carried out. At that time, the circulating pump 48 and the fuel pump 60 continue operating, and the aqueous fuel solution with, e.g., the second concentration FC2, is supplied to the fuel cell 12. As a result, the amount of heat generated by the fuel cell 12 becomes larger than that during the second freeze proofing operation. In the following, the third freeze proofing operation will be described in more detail.

As mentioned above, the third freeze proofing operation is carried out in the case where the temperature of the fuel cell 12 becomes lower and the second freeze proofing operation is not sufficient to prevent freezing. With use of the table of cell temperature vs. required amount of heat that is pre-stored in the memory 58c in the control unit 58, the fuel cell 12 is made to generate power in accordance with the cell temperature FT, such that the amount of heat generated due to power generation by the fuel cell 12 exceeds the required amount of heat. Thus, with use of heat generated due to power generation by the fuel cell 12, the respective temperatures of the parts of the circulation system can be raised to become higher than 0° C.; and freezing can thereby be prevented. Note that the table of cell temperature vs. required amount of heat is a result of tabulating a group of discrete data of the relation between the cell temperature (or ambient temperature) and the required amount of heat, as shown in the graph of FIG. 4. Alternatively, in the memory 12c, a relational formula expressing the relation between the cell temperature (or ambient temperature) and the required amount of heat as shown in the graph of FIG. 4, can be stored, in place of the table of cell temperature vs. required amount of heat. Next, a detailed description will be given on heat generation that is due to power generation by the fuel cell.

The fuel cell has a feature whereby losses increase, as current generated increases. Such losses include cathode reaction resistance, anode reaction resistance, polymer electrolyte membrane resistance, etc. All of these losses turn into heat. Furthermore, the amount of heat generated by the fuel cell adds up to be the amount of heat generated due to these losses plus the amount of heat generated due to the above-mentioned fuel crossover. Therefore, regarding power generation for freeze proofing, the fuel cell is preferably made to generate power at a point Psht on a characteristic curve of current generated vs. voltage generated as shown in FIG. 5, the point Psht resulting from shifting a point Pmax in a direction in which current generated increases, the point Pmax being where maximum efficiency in power generation can be achieved. At that time, a current generated Is is preferably set, such that RG=Is/Ix, i.e., a ratio between the current generated Is corresponding to the point Psht and a current generated Ix corresponding to the point Pmax, is within a range of 1.05 to 1.15.

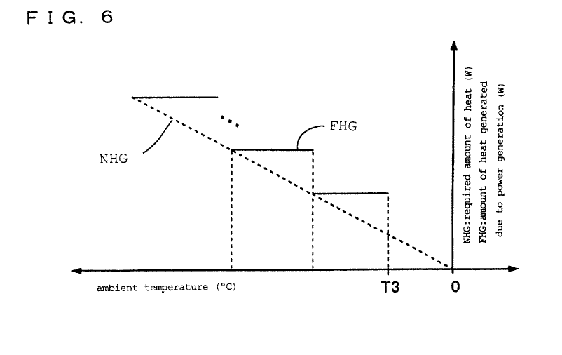

In the third freeze proofing operation, the power generated by the fuel cell need not necessarily be increased in proportion to the increase in the required amount of heat. As shown in FIG. 6, the amount of power generated by the fuel cell 12 may be fixed over a predetermined temperature range, provided that an amount of generated heat FGH, due to power generation by the fuel cell 12, exceeds a required amount of heat NHG. That is, the amount of power generated may be increased stepwise, in accordance with changes in the ambient or cell temperature.

Note that a determination whether or not to carry out the third freeze proofing operation may be made, by determining in the step ST4 whether or not the cell temperature FT has become further lower during the second freeze proofing operation, instead of determining in the step ST4 whether or not the cell temperature FT is equal to or lower than the third temperature T3. In the case of such alteration, if the cell temperature FT has become further lower during the second freeze proofing operation, a step ST6 follows and the third freeze proofing operation is carried out; if the cell temperature FT has not become further lower during the second freeze proofing operation, the third freeze proofing operation is not carried out, and instead, the step ST5 follows and the second freeze proofing operation is continued as before.

Moreover, during the first and second freeze proofing operations, when the amount of power stored by the storage cell 54 is monitored and becomes equal to or smaller than a predetermined amount, the fuel cell 12 may be made to generate power for charging the storage cell 54, regardless of the cell temperature FT. Alternatively, since the amount of the oxygen remaining at the cathode presumably becomes smaller after a certain time elapses from the start of the first or second freeze proofing operation, the air pump 62 may be made to start at a point after a predetermined time has elapsed, to send to the cathode, sufficient amount of the air for heat generation by fuel crossover.

In the foregoing embodiment, although a description was given on the system in which all three of the freeze proofing operations are carried out, the system may also be structured such that, e.g., only the first or second freeze proofing operation alone is carried out. Alternatively, the system may be structured such that the first and third freeze proofing operations are carried out in a combination, or the second and third freeze proofing operations are carried out in a combination. Further alternatively, the system may be structured such that the first and second freeze proofing operations are carried out in a combination.

As such, according to the foregoing embodiment, the fuel is supplied to the fuel cell, without the fuel cell being required to generate power. Thus, fuel crossover occurs, and the fuel cell can be heated by the resultant heat generation. As such, the fuel cell can be effectively prevented from freezing, with small amount of the fuel consumed. Moreover, in the case where the fuel cell cannot be prevented from freezing with only the heat generation caused by the fuel crossover, the fuel cell is made to generate power so that it becomes heated. Thus, the fuel cell can be prevented from freezing, with more certainty.

### INDUSTRIAL APPLICABILITY

The fuel cell system of the present invention is useful as the power source for small mobile electronic devices such as laptop computers, cellular phones, and personal digital assistants (PDAs); outdoor recreation; and emergency backup power. Moreover, the system can be applied for use as the power source for electric scooters, etc.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### EXPLANATION OF REFERENCE NUMERALS

10 fuel cell system

12 fuel cell

38 storage cell

3a, 3b, 3c, 3d pipe

48 circulating pump

50 circulation tank

54 storage cell

56 fuel tank

58 control unit

58a calculating unit

58b determining unit

58c memory

60 fuel pump

62 air pump

64 temperature sensor

1. A fuel cell system comprising:
a fuel cell including: an anode to which a water-soluble fuel is supplied; a cathode to which an oxidant is supplied; and a water-permeable electrolyte membrane interposed between the anode and the cathode;
a fuel tank which stores the fuel;
a first fuel supply unit which supplies an aqueous fuel solution including the fuel and water, to the anode;
a second fuel supply unit which supplies the fuel stored in the fuel tank, to the first fuel supply unit;
an oxidant supply unit which supplies the oxidant to the cathode;
a temperature sensor which detects a temperature FT of the fuel cell; and
a control unit which controls the first, second, and oxidant supply units; and which controls the fuel cell whether to start or stop power generation,
the control unit allowing at least the first fuel supply unit to operate while the fuel cell is stopped from generating power, provided that the temperature FT of the fuel cell while being stopped from generating power, is equal to or lower than a first reference temperature relating to freezing of water and is also higher than a second reference temperature.

2. The fuel cell system in accordance with claim 1, wherein the first reference temperature is a first temperature T1 being higher than 0° C. and equal to or lower than 5° C.; and the second reference temperature is a third temperature T3 being higher than −5° C. and equal to or lower than −2° C.

3. The fuel cell system in accordance with claim 2, wherein the fuel includes methanol, and the first fuel supply unit supplies an aqueous methanol solution having a first concentration FC1 of 0.2 to 0.5 mol/L, to the anode.

4. The fuel cell system in accordance with claim 1, wherein the first reference temperature is a second temperature T2 being higher than −2° C. and equal to or lower than 0° C.; and the second reference temperature is a third temperature T3 being higher than −5° C. and equal to or lower than −2° C., and the control unit allows both the first and second fuel supply units to operate, when the temperature FT is equal to or lower than the first reference temperature.

5. The fuel cell system in accordance with claim 4, wherein the fuel includes methanol, and the first fuel supply unit supplies an aqueous methanol solution having a second concentration FC2 of 0.5 to 4 mol/L, to the anode.

6. The fuel cell system in accordance with claim 1 wherein the control unit allows the first, second, and oxidant supply units to operate, and the fuel cell to generate power, when the temperature FT is equal to or lower than the second reference temperature.
